(19) United States
(12) Patent Application Publication
(10) Pub. No.: US 2007/0282521 A1
(43) Pub. Date: Dec. 6, 2007

(54) Interactive Mapping Enhancement to a Vehicle Navigation System

(75) Inventor: Larry J. Broughton, Lansing, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/421,789

(22) Filed: Jun. 2, 2006

(51) Int. Cl. G01C 21/00

(52) U.S. Cl. 701/200

(57) ABSTRACT

An onboard vehicle navigation system as described herein is enhanced with data obtained from an interactive computer-based mapping application, which may be readily available from one or more websites. The mapping application generates mapping data that indicates a desired destination and/or a proposed route to that destination. The mapping data is stored in a portable data storage device, such as a USB flash memory device, which can be connected to a data port on the vehicle. The mapping data can be downloaded to the onboard vehicle navigation system from the portable data storage device and used in lieu of programming inputs that would otherwise have been entered by the operator of the vehicle.

### TECHNICAL FIELD

The present invention generally relates to vehicle navigation and route planning systems. More particularly, the present invention relates to a vehicle navigation system that processes data generated by an interactive mapping application.

### BACKGROUND

A vehicle navigation system generally provides navigation instructions, location data, and map information to the vehicle operator. The prior art is replete with vehicle navigation systems that attempt to optimize a route based upon different factors. Route calculation is typically performed by examining a number of possible paths, and selecting the “best” path according to a number of optimization rules. In order to perform an accurate route calculation, the vehicle navigation system needs to have knowledge of the desired destination.

The destination point processed by a conventional onboard vehicle navigation system is typically obtained from the driver or operator of the system. Unfortunately, many vehicle navigation systems are extremely difficult to learn and operate, include non-intuitive user interfaces and menu structures, and take a long time to program destination points. Indeed, “technophobes” who are intimidated by such navigation systems may simply choose to disregard or disable the navigation systems altogether.

Accordingly, it is desirable to have an onboard vehicle navigation system that is simple and easy to operate. In addition, it is desirable to have an onboard vehicle navigation system that has an intuitive and familiar destination point programming procedure. Furthermore, other desirable features and characteristics of the present invention will become apparent from the subsequent detailed description and the appended claims, taken in conjunction with the accompanying drawings and the foregoing technical field and background.

### BRIEF SUMMARY

An onboard vehicle navigation system as described herein can be easily programmed with a desired destination point in a manner that need not rely on a complicated manipulation of a user interface and that need not rely on a non-intuitive data entry procedure. The vehicle navigation system leverages an interactive mapping application, which may be readily available online.

The above and other aspects of the invention may be carried out in one form by a navigation system for instructing an operator of a vehicle. The navigation system includes: a portable data storage device configured to store data generated by an interactive computer-based mapping application, the data corresponding to a destination for the operator; and an onboard vehicle navigation system configured to receive the portable data storage device to facilitate transfer of data from the portable data storage device to the onboard vehicle navigation system, the onboard vehicle navigation system being configured to generate a proposed route in response to data downloaded from the portable data storage device.

### BRIEF DESCRIPTION OF THE DRAWINGS

The present invention will hereinafter be described in conjunction with the following drawing figures, wherein like numerals denote like elements, and

FIG. 1 is a schematic representation of an operating environment for a vehicle navigation system configured in accordance with an example embodiment of the invention;

FIG. 2 is a schematic representation of another operating environment for a vehicle navigation system configured in accordance with an example embodiment of the invention;

FIG. 3 is a schematic representation of a vehicle navigation system configured in accordance with an example embodiment of the invention;

FIG. 4. is a diagram that depicts the handling of navigation data for a vehicle navigation system configured in accordance with an example embodiment of the invention;

FIG. 5 is a diagram that depicts the handling of navigation data for a vehicle navigation system configured in accordance with another example embodiment of the invention;

FIG. 6 is a schematic representation of a portable data storage device configured in accordance with an example embodiment of the invention; and

FIG. 7 is a flow diagram of a navigation process that may be performed by an example vehicle navigation system.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of practical vehicle navigation system platforms, architectures, and deployments, and that the particular system described herein is merely one exemplary application for the invention.

For the sake of brevity, conventional techniques related to signal processing, data transmission, general vehicle navigation system operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly joined to (or directly communicates with) another component/feature, and not necessarily mechanically. As used herein, unless expressly stated otherwise, “coupled” means that one component/feature is directly or indirectly joined to (or directly or indirectly communicates with) another component/feature, and not necessarily mechanically. Thus, although the schematic block diagrams depict example arrangements of elements, additional intervening elements, devices, features, or components may be present in an actual embodiment (assuming that the functionality of the systems or subsystems are not adversely affected).

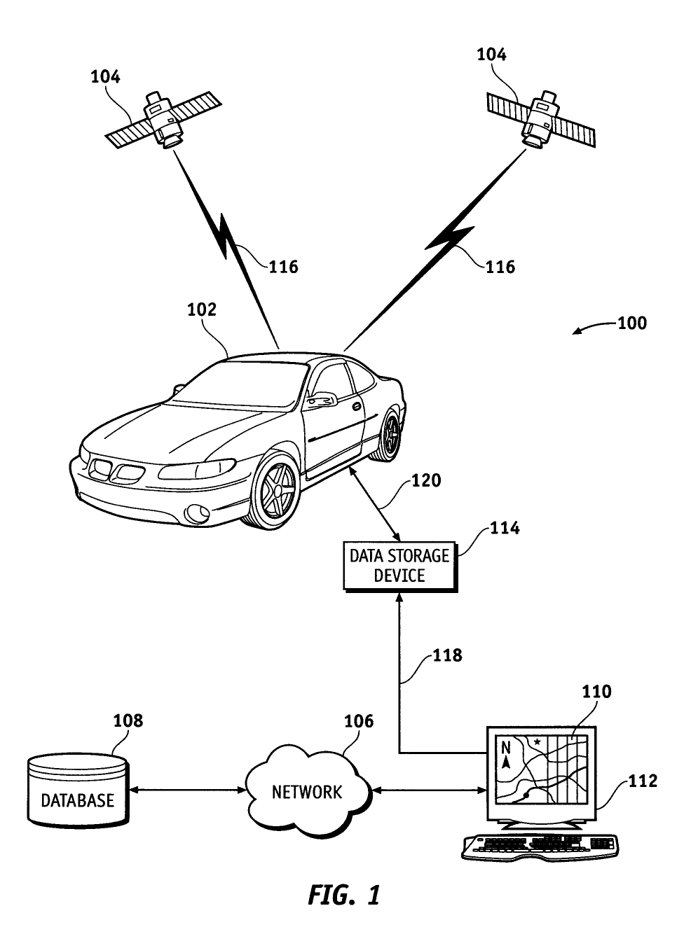

FIG. 1 is a schematic representation of an example environment 100 in which a vehicle navigation system may be deployed. A vehicle navigation system according to a practical embodiment of the invention may be deployed in environment 100. Environment 100 generally includes a vehicle 102, global positioning system (“GPS”) satellites 104, a data communication network 106, one or more mapping data sources or databases 108, and an interactive computer-based mapping application 110, which can be manipulated via a computing device 112. The example depicted in FIG. 1 also includes a portable data storage device 114 that may be transported to vehicle 102 by a user.

Although vehicle 102 is depicted as an automobile, the invention is not limited to automobile applications (the navigation system described herein may be utilized for boats, bicycles, and the like). Vehicle 102 preferably includes an onboard vehicle navigation system (not shown) that is suitably configured to provide navigation instructions to the operator of vehicle 102, where such navigation instructions direct the operator to drive along a proposed route from a desired starting location to a desired destination location. In practice, the vehicle navigation system may be incorporated into an otherwise conventional onboard vehicle computer system.

In a practical embodiment, the vehicle navigation system deployed in vehicle 102 may include logical or functional elements realized by hardware, software, firmware, or any combination thereof, such as one or more processors, controllers, memory elements, or the like. In accordance with the practices of persons skilled in the art, embodiments of the invention may be described herein with reference to symbolic representations of operations that may be performed by various logical, functional, or processor-based components. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (“EROM”), a floppy diskette, a CD-ROM or any optical disk, a hard disk, a fiber optic medium, a radio frequency (“RF”) link, or the like. Data signals referred to herein may include any signal that can propagate over a transmission medium such as electronic network channels, optical fibers, air, electromagnetic paths, or RF links.

Environment 100 supports one practical vehicle navigation system that leverages a GPS system to obtain accurate position data for vehicle 102. In this regard, GPS satellites 104 may communicate, via links 116, with a conventional GPS receiver located at vehicle 102. The operation of GPS systems is known to those skilled in the art, and such known features will not be described herein. Alternatively (or additionally), the vehicle navigation system may utilize positioning data provided by a cellular telecommunication network or any appropriate locating system. Alternatively (or additionally), the vehicle navigation system may rely on the operator to enter the current location or desired starting location (e.g., an address), and the vehicle navigation system need not determine the real-time position of vehicle 102.

Mapping data source 108 generally contains current cartographic, topological, location, and possibly other useful data that can be accessed and/or processed by mapping application 110. In environment 100, mapping application 110 accesses mapping data source 108 via data communication network 106 and one or more communication links. Data communication network 106 may be, for example, a cellular telecommunication network, the Internet, a LAN, any known network topology or configuration, portions thereof, or any combination thereof. In practical embodiments, mapping application 110 is a web-based interactive software application that can be accessed, manipulated, and used via any suitably configured web browser. In the example embodiment, a web browser installed at computing device 112 allows an operator to interact with mapping application 110. Although computing device 112 is depicted as a standard desktop computer, computing device 112 may be realized as a notebook computer, a palmtop computer, a smart phone, a personal digital assistant, a web-enabled wireless device, or the like.

Interactive computer-based mapping application 110 may support any number of well known features and functions. For example, mapping application 110 is generally configured to receive user input (an address, a zip code, a city name, a state name, an intersection, an airport name or identifier, a name of a major attraction, or the like) and to generate and process mapping data corresponding to the user input. Mapping application 110 may generate and display an interactive map for the entered address or destination point, generate and display travel directions from an entered starting point to the entered destination point, generate and display proposed travel routes to the entered destination, or the like. In the example embodiments described below, mapping application 110 is suitably configured to generate mapping data corresponding to a user-entered destination. Such common features are supported by a number of existing online applications, including MAPQUEST, MULTIMAP, the interactive map feature of YAHOO, and others.

As described in more detail below, mapping data generated by mapping application 110 can be exported for use by the vehicle navigation system. The mapping data may include, without limitation: location information for a starting point and/or a destination; route information for a destination; GPS coordinates for a starting point and/or a destination; longitude/latitude coordinates for a starting point and/or a destination; or the like. In the example environment 100 of FIG. 1, a user can load such mapping data (or data related to, based upon, or derived from such mapping data) from computing device 112 into portable data storage device 114, physically transport portable data storage device 114 to vehicle 102, and download the stored contents into the vehicle navigation system. The arrow 118 in FIG. 1 represents the loading of data into portable data storage device 114, and the arrow 120 in FIG. 1 represents the transporting of the portable data storage device 114.

In example embodiments, portable data storage device 114 is a small, handheld, and easy-to-use device that is configured to store data generated by mapping application 110. In practice, portable data storage device 114 may be, without limitation: a flash memory device; an optical memory disk such as a CD-ROM, a DVD-ROM, or the like; a magnetic memory device such as a floppy disk or a magnetic hard drive. In particular, portable data storage device 114 may include a suitable connector, port, or interface that allows data uploading and downloading. The connector, port, or interface may be compatible with any suitable technology, standard, or protocol, including, without limitation: USB, IEEE 1394, Ethernet, or the like.

The use of portable data storage device 114 allows the operator to bypass any confusing, time consuming, or difficult-to-use data entry procedures or programming that might otherwise be mandated by the vehicle navigation system. Moreover, the use of portable data storage device 114 can be an added value feature for car rental agencies. For example, a rental representative could store mapping data or navigation data (e.g., for a hotel or other destination for the renter) in portable data storage device 114, and instruct the renter to simply connect portable data storage device 114 to the respective port or receptacle in the vehicle.

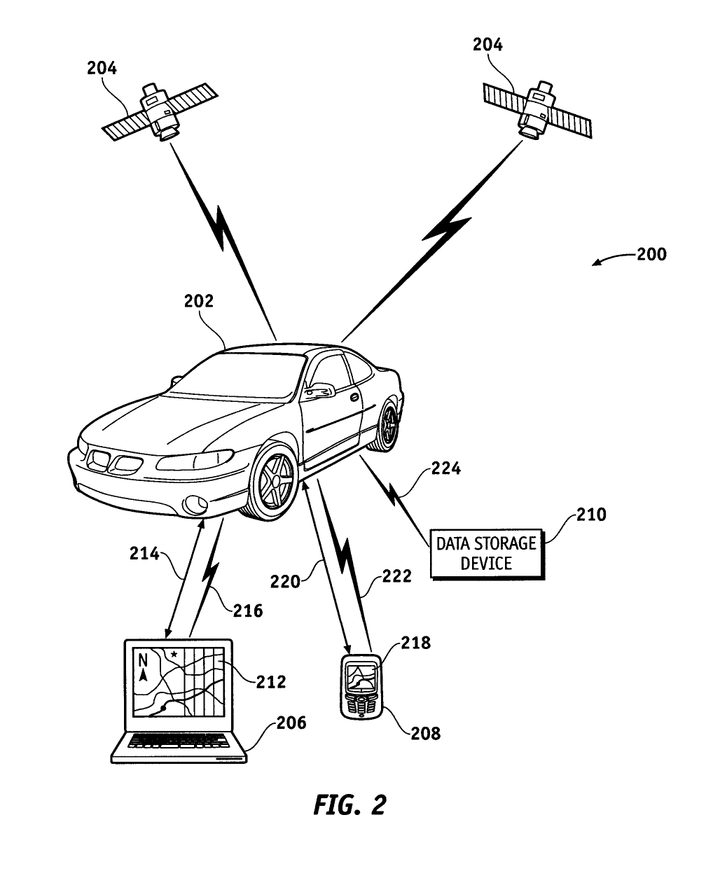

FIG. 2 is a schematic representation of an operating environment 200 for a vehicle navigation system configured in accordance with another example embodiment of the invention. A vehicle navigation system according to a practical embodiment of the invention may be deployed in environment 200. Environment 200 is similar to environment 100 described above; common elements and features will not be redundantly described in the context of environment 200. Environment 200 generally includes a vehicle 202 and GPS satellites 204 as described above. Although not shown in FIG. 2, environment 200 may include one or more mapping data sources or databases as described above.

FIG. 2 shows a number of optional or alternative components in environment 200, these optional components illustrate the flexible nature of a vehicle navigation system configured in accordance with an example embodiment of the invention. In this regard, environment 200 includes a portable computing device 206, a handheld computing device 208, and a portable data storage device 206. Portable data storage device 210 may be generally configured as described above.

Portable computing device 206 may be realized as a laptop computer, a palmtop computer, or the like. In this example, portable computing device 206 is configured to allow its user to access an interactive computer-based mapping application 212 (described above), which can be manipulated via portable computing device 212. Portable computing device 206 is suitably configured to accommodate transmission of mapping data (and/or navigation data as explained below) to vehicle 202 and/or to the onboard vehicle navigation system of vehicle 202. Depending upon the particular implementation, the data transmission from portable computing device 206 may be via a wired link 214, a wireless link 216, or a combination thereof. For purposes of the vehicle navigation system, portable computing device 206 includes or functions as a portable data storage device. Consequently, portable computing device 206 may be utilized in lieu of a separate and stand alone data storage device.

Handheld computing device 208 may be realized as a pager, a wireless telephone, a smart phone, a pocket PC, a personal digital assistant, a mobile email device, a digital media player, or the like. In this example, handheld computing device 208 is configured to allow its user to access an interactive computer-based mapping application 218 (as described above), which can be manipulated via handheld computing device 208. In example embodiments, mapping application 218 may be a scaled down (in terms of screen size and/or functionality) version of mapping application 212. Handheld computing device 208 is suitably configured to accommodate transmission of mapping data (and/or navigation data as explained below) to vehicle 202 and/or to the onboard vehicle navigation system of vehicle 202. Depending upon the particular implementation, the data transmission from handheld computing device 208 may be via a wired link 220, a wireless link 222, or a combination thereof. For purposes of the vehicle navigation system, handheld computing device 208 includes or functions as a portable data storage device. Consequently, handheld computing device 208 may be utilized in lieu of a separate and stand alone data storage device.

Portable data storage device 210 may be generally configured as described above in connection with environment 100. Briefly, portable data storage device 210 can store mapping data and/or data related to mapping data, such as navigation data that is formatted for compatibility with the native navigation system processing logic used by the onboard navigation system. In contrast to portable data storage device 114 (see FIG. 1), a wireless data communication link 224 may be utilized for data communication between portable data storage device 210 and vehicle 202. In this example, portable data storage device 210 includes a suitably configured transmitter or radio module that enables wireless downloading of data into the vehicle navigation system.

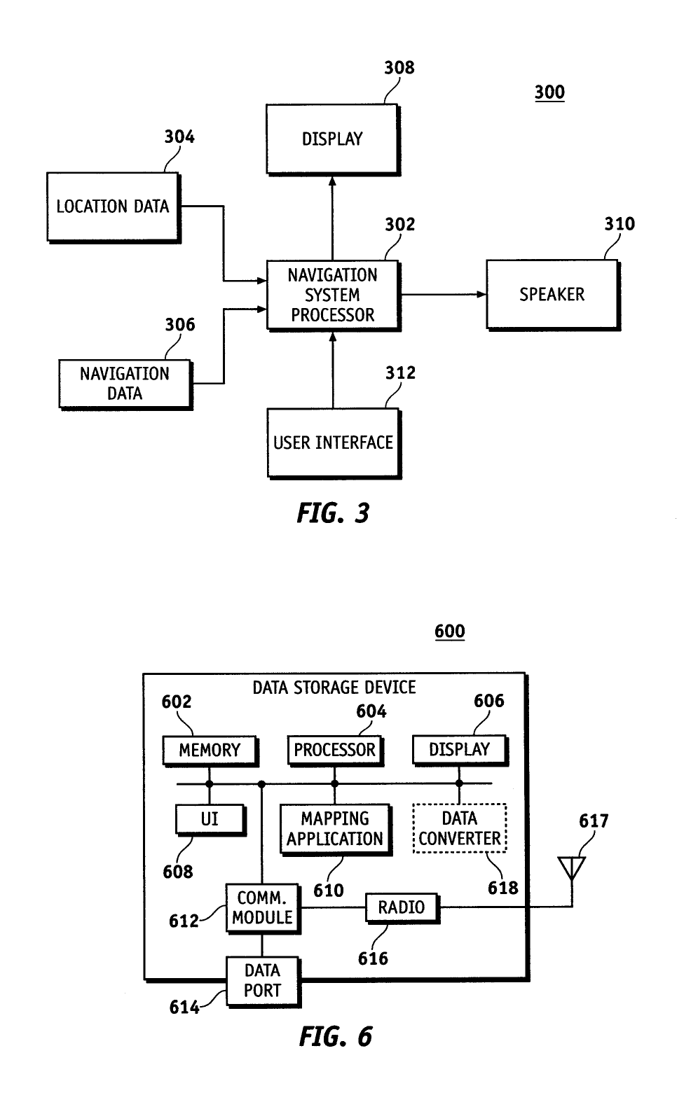

FIG. 3 is a schematic representation of an onboard vehicle navigation system 300 configured in accordance with an example embodiment of the invention. Vehicle navigation system 300 generally includes or utilizes a navigation system processor 302, location data 304 that is processed by navigation system processor 302, navigation data 306 that is processed by navigation system processor 302, a display element 308 coupled to navigation system processor 302, a speaker element 310 coupled to navigation system processor 302, and a user interface 312 coupled to navigation system processor 302. In practice, the components are coupled to navigation system processor 302 in a manner that facilitates the communication of data, instructions, control signals, and possibly other signals to and from navigation system processor 302. Of course, a practical vehicle navigation system 300 may include additional components configured to perform conventional functions that are unrelated to the invention.

Generally, navigation system processor 302 is configured to perform or otherwise support the various operations and functions described herein. Location data 304 preferably provides the current vehicle location or position to navigation system processor 302. In one practical embodiment, location data 304 is generated by (or obtained from) an onboard GPS receiver/processor that derives the current position of the vehicle from GPS data received by the vehicle in real-time.

Navigation data 306 represents locally stored, cached, downloaded, or accessible navigation data, which can be processed by navigation system processor 302. For example, in a fully onboard implementation, navigation data 306 may be maintained on one or more hard disks, semiconductor memory devices, portable storage media, or the like. In some embodiments, navigation data 306 can be downloaded from a portable data storage device and saved in an onboard memory cache that temporarily stores the navigation data 306. Navigation data 306 is formatted for compatibility and compliance with the native navigation system processing logic utilized by navigation system 300. In other words, navigation data 306 can be understood and processed by navigation system processor 302, using its native processing logic, to generate a proposed route in response to navigation data 306 and/or to generate other user feedback as mentioned previously. Referring again to FIG. 1, mapping application 110 may generate mapping data that is not fully compatible with navigation system 300. Under such circumstances, the mapping data is reformatted and converted into navigation data 306 before native processing begins.

Display element 308, speaker element 310, and user interface 312 may be configured in accordance with conventional vehicle navigation systems to enable onboard interaction with the vehicle operator. Display element 308 may be a suitably configured LCD, plasma, CRT, or head-up display, which may or may not be utilized for other vehicle functions. In accordance with known techniques, navigation system processor 302 can provide rendering control signals to display element 308 to cause display element 308 to render maps, proposed routes, roads, navigation direction arrows, and other graphical elements as necessary to support the function of vehicle navigation system 300.

Speaker element 310 may be devoted to vehicle navigation system 300, it may be realized as part of the audio system of the vehicle, or it may be realized as part of another system or subsystem of the vehicle. Briefly, speaker element 310 may receive audio signals from navigation system processor 302, where such audio signals convey navigation instructions, user prompts, warning signals, and other audible signals as necessary to support the function of vehicle navigation system 300.

Although not shown in FIG. 3, vehicle navigation system 300 may also include a printer that generates navigation instructions in a suitable hard copy format. For example, the printer may produce a printed map that indicates the proposed route, or a printed step-by-step route plan.

User interface 312 is configured to allow the vehicle operator to enter data and/or control the functions and features of vehicle navigation system 300. For example, the operator can manipulate user interface 312 to enter a starting location and a destination location for the vehicle, where the starting and destination locations are utilized by vehicle navigation system 300 for purposes of route planning. If the desired starting location corresponds to the current vehicle location, then the operator need not enter the starting location if vehicle navigation system 300 includes a source of current vehicle position information. User interface 312 may be realized using any conventional device or structure, including, without limitation: a keyboard or keypad; a touch screen (which may be incorporated into display element 308); a voice recognition system; a cursor control device; a joystick or knob; or the like.

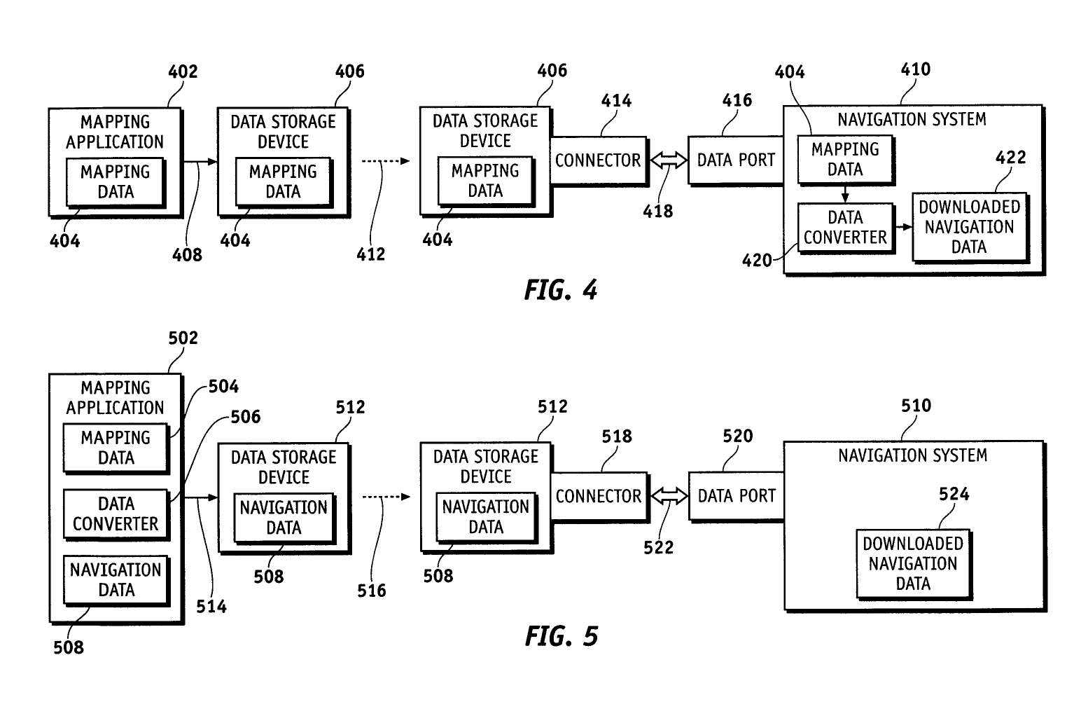

FIG. 4. is a diagram that depicts the handling of navigation data for a vehicle navigation system configured in accordance with an example embodiment of the invention. In this example, a user manipulates an interactive computer-based mapping application 402, which eventually generates mapping data 404. Mapping data 404 may correspond to, or otherwise indicate, a user-entered destination. For example, mapping data 404 may represent location data for the destination, including, without limitation: an address, a city, a state, a county, a building, an attraction (such as a movie theater, an amusement park, a recreation center, a library, etc.), an airport, a restaurant, or the like. Alternatively (or additionally), mapping data 404 may represent route information for the destination, including, without limitation: one or more proposed routes to the destination, mileage, travel time, or the like. In the example of FIG. 4, mapping data 404 may be in the native format of mapping application 402.

In this example embodiment, mapping data 404 can be loaded into a portable data storage device 406 in any suitable manner. The arrow 408 in FIG. 4 represents the loading of mapping data 404 into portable data storage device 406. In this regard, data storage device 406 may be a USB compatible device that can be connected to a USB port on the computing device in which mapping application 402 is executing. The computing device, mapping application 402, and/or portable data storage device 406 may be suitably configured to manage the loading of mapping data 404 into portable data storage device 406, and such loading may even be performed automatically after portable data storage device 406 is connected. In alternate embodiments (see above description of FIG. 1 and FIG. 2), mapping data 404 may be loaded into portable data storage device 406 using a wireless data link.

Once mapping data 404 is loaded into portable data storage device 406, the user can physically transport portable data storage device 406 to an onboard vehicle navigation system 410. The arrow 412 in FIG. 4 represents portable data storage device 406 in transit. In this example, portable data storage device 406 includes a suitably configured connector 414, and vehicle navigation system 410 includes a data port 416 that is configured to receive and mate with connector 414. Data port 416 may be, for example, a USB port that is easily accessible to the vehicle operator; data port 416 may be physically located on the front panel of a dashboard mounted navigation system, near other vehicle control elements, on a center console of the vehicle, or elsewhere within reach of the driver. Alternatively, if portable data storage device 404 is an optical disk, data port 416 may be the input of an onboard CD/DVD player. The specific physical and electrical characteristics of connector 414 and data port 416 may vary from one implementation to another—connector 414 and data port 416 simply need to be configured to facilitate downloading of data from portable data storage device 406 to vehicle navigation system 410. The arrow 418 in FIG. 4 represents this downloading of mapping data 404.

Onboard vehicle navigation system 410 may include a suitable amount of memory configured to store the downloaded mapping data 404. In this example embodiment, a suitably configured data converter 420 is implemented in vehicle navigation system 410. Data converter 420 is configured to convert mapping data 404 into navigation data 422. As mentioned above, navigation data 422 may correspond to the destination that was originally entered by the user of mapping application 402. In practice, the downloaded navigation data 422 depicted in FIG. 4 may correspond to the navigation data 306 depicted in FIG. 3.

FIG. 5 is a diagram that depicts the handling of navigation data for a vehicle navigation system configured in accordance with another example embodiment of the invention. Some aspects of the system depicted in FIG. 5 are similar, identical, or equivalent to aspects of the system depicted in FIG. 4, and such common aspects will not be redundantly described in the context of FIG. 4. In the example depicted in FIG. 4, a user manipulates an interactive computer-based mapping application 502 that eventually generates mapping data 504, which may be in the native format of mapping application 502.

In this example embodiment, a suitably configured data converter 506 is implemented in mapping application 502. Data converter 506 is configured to convert mapping data 504 into navigation data 508. Navigation data 508 is formatted in accordance with the operating requirements and native processing capabilities of an onboard vehicle navigation system 510. In this regard, mapping application 502 is preferably written with prior knowledge of the operating requirements and data formatting parameters of vehicle navigation system 510.

In this example embodiment, navigation data 508 can be loaded into a portable data storage device 512 in any suitable manner. The arrow 514 in FIG. 5 represents the loading of navigation data 508 into portable data storage device 512.

Once navigation data 508 is loaded into portable data storage device 512, the user can physically transport portable data storage device 512 to onboard vehicle navigation system 510. The arrow 516 in FIG. 5 represents portable data storage device 512 in transit. In this example, portable data storage device 512 includes a suitably configured connector 518, and vehicle navigation system 510 includes a data port 520 that is configured to receive and mate with connector 518. The specific physical and electrical characteristics of connector 518 and data port 520 may vary from one implementation to another—connector 518 and data port 520 simply need to be configured to facilitate downloading of data from portable data storage device 512 to vehicle navigation system 510. The arrow 522 in FIG. 5 represents this downloading of navigation data 508.

Onboard vehicle navigation system 510 may include a suitable amount of memory configured to store the downloaded navigation data 524. As mentioned above, navigation data 524 may correspond to the destination that was originally entered by the user of mapping application 502. In practice, the downloaded navigation data 524 depicted in FIG. 5 may correspond to the navigation data 306 depicted in FIG. 3.

In the example embodiments described above in connection with FIG. 4 and FIG. 5, the portable data storage devices may be “pure” memory devices such as flash memory devices, optical disks, magnetic memory, or the like. In alternate embodiments, the onboard vehicle navigation system may be compatible with more complex portable data storage devices. In this regard, FIG. 6 is a schematic representation of a portable data storage device 600 configured in accordance with an example embodiment of the invention. Portable data storage device 600 generally includes a suitable amount of memory 602, a processor 604 for executing processing logic, a display element 606, user interface features 608, a computer-based interactive mapping application 610, a data communication module 612, a data port 614, a radio module 616, and an antenna 617. Portable data storage device 600 may optionally include a data converter 618. The dashed lines in FIG. 6 indicate the optional nature of data converter 618. These components may be interconnected using any suitable interconnection architecture 620. In practice, portable data storage device 600 may be realized as a personal digital assistant, a portable computing device, a smart phone, or the like.

Those of skill in the art will understand that the various illustrative blocks, modules, circuits, and processing logic described in connection with portable data storage device 600 (and other devices, elements, and components disclosed here) may be implemented in hardware, computer software, firmware, or any combination of these. To clearly illustrate this interchangeability and compatibility of hardware, firmware, and software, various illustrative components, blocks, modules, circuits, and processing steps may be described generally in terms of their functionality. Whether such functionality is implemented as hardware, firmware, or software depends upon the particular application and design constraints imposed on the embodiment. Those familiar with the concepts described here may implement such functionality in a suitable manner for each particular application, but such implementation decisions should not be interpreted as causing a departure from the scope of the present invention.

Referring again to FIG. 6, memory 602, processor 604, display element 606, and user interface features 608 may be suitably configured to support the desired functionality of portable data storage device 600. Briefly, display element 606 may be suitably configured to enable portable data storage device 600 to display maps, mapping data, navigation data, cartographic information, topological information, or the like. In this example embodiment, display element 606 is also configured to enable device 600 to display web pages, thus facilitating user interaction with mapping application 610. Of course, display element 606 may also be configured to display other information associated with other functions of device 600 (e.g., telephone features, email features, address book features, and the like).

Processor 604 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

Memory 602 may be realized as RAM memory, flash memory, EPROM memory, EEPROM memory, registers, a hard disk, a removable disk, a CD-ROM, or any other form of storage medium known in the art. In this regard, memory 602 can be coupled to processor 604 such that processor 604 can read information from, and write information to, memory 602. In the alternative, memory 602 may be integral to processor 604. As an example, processor 604 and memory 602 may reside in an ASIC.

Portable data storage device 600 may include mapping application 610, which has the characteristics described above. In such an embodiment, device 600 may also include data converter 618 to convert mapping data into navigation data that is compatible with the native processing logic of the vehicle navigation system. Alternatively, if the vehicle navigation system includes a data converter, then device 600 need not employ data converter 618, and device 600 can simply transfer mapping data to the vehicle navigation system.

An embodiment of portable data storage device 600 may employ any number of data communication modules 612. For simplicity, the example described here employs one data communication module 612. Data communication module 612 is suitably configured to support data communication between device 600 and other compatible devices or systems, including, without limitation: other portable data storage devices; vehicle navigation systems; wireless devices; computer networks; or the like. Moreover, depending upon the particular implementation, data communication module 612 may be configured to support wireless data communication, wired/cabled data communication, or both. In this regard, data port 614 supports wired/cabled data communication, while radio module 616 and antenna 617 support wireless data communication.

For wireless transmissions of local communications, data communication module 612, radio module 616, and antenna 617 support one or more wireless data communication protocols that are also supported by the vehicle navigation system that communicates with portable data storage device 600. Any number of suitable wireless data communication protocols, techniques, or methodologies may be supported by device 600, including, without limitation: RF; IrDA (infrared); Bluetooth; ZigBee (and other variants of the IEEE 802.15 protocol); IEEE 802.11 (any variation); spread spectrum; frequency hopping; cellular/wireless/cordless telecommunication protocols; wireless home network communication protocols; paging network protocols; magnetic induction; satellite data communication protocols; GPRS; and proprietary wireless data communication protocols.

For transmissions of data over a cable, a wired connection, or other physical link, data communication module 612 and data port 614 support one or more wired/cabled data communication protocols that are also supported by the vehicle navigation system that communicates with portable data storage device 600. Any number of suitable data communication protocols, techniques, or methodologies may be supported by device 600, including, without limitation: Ethernet; home network communication protocols; USB; IEEE 1394 (Firewire); and proprietary data communication protocols.

In the context of example embodiments of the invention, data communication module 612 is suitably configured to support transmission of mapping data and/or navigation data from portable data storage device 600 to the respective onboard vehicle navigation system. Device 600 is one example of a data storage device that contains additional functionality. Accordingly, device 600 may also be utilized as data storage device 406 (see FIG. 4) or data storage device 512 (see FIG. 5).

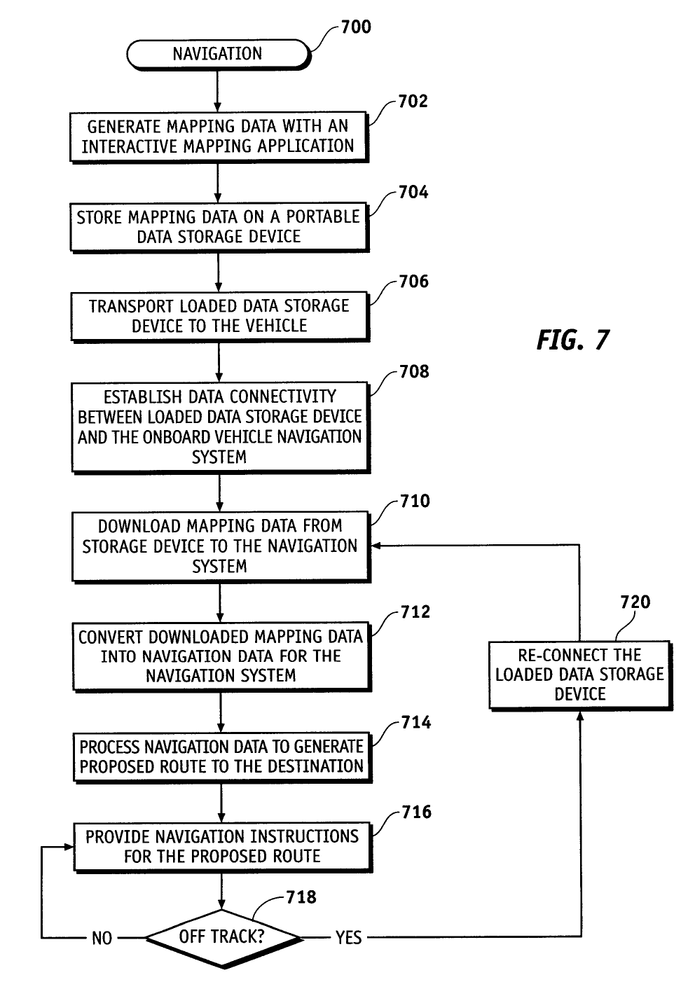

FIG. 7 is a flow diagram of a navigation process 700 that may be performed by an example vehicle navigation system. The various tasks performed in connection with process 700 may be performed by software, hardware, firmware, or any combination. For illustrative purposes, the following description of process 700 may refer to elements mentioned above in connection with FIGS. 1-6. In embodiments, portions of process 700 may be performed by different elements of the described system, e.g., a mapping application, a portable data storage device, or a vehicle navigation system. It should be appreciated that process 700 may include any number of additional or alternative tasks, the tasks shown in FIG. 7 need not be performed in the illustrated order, and process 700 may be incorporated into a more comprehensive procedure or process having additional functionality not described in detail here.

Navigation process 700 may begin by generating mapping data with an interactive computer-based mapping application (task 702). The mapping data may indicate, for example, a user-entered destination for an operator of a vehicle. Process 700 may then store the mapping data on a suitably configured portable data storage device (task 704) to obtain a loaded storage device. In alternate embodiments, process 700 may convert the mapping data into related navigation data, then store the navigation data on the portable data storage device. In this example, the loaded storage device can be transported to the vehicle (task 706) at any time. Unless the mapping data in the loaded storage device becomes corrupted or deleted, task 706 may be performed at any time after task 704.

Eventually, navigation process 700 establishes data connectivity between the loaded storage device and an onboard vehicle navigation system (task 708). In this example, task 708 may be accomplished by coupling a connector of the loaded storage device to a compatible data port of the onboard vehicle navigation system. As described above, the connector and the data port are configured to mate with each other to facilitate data transfer. In this regard, the mapping data can be downloaded from the loaded storage device to the onboard vehicle navigation system (task 710) using any suitable technique.

In this example embodiment, navigation process 700 converts the mapping data into navigation data that is formatted for compatibility with the onboard vehicle navigation system (task 712). Once this conversion is complete, the vehicle navigation system can process the navigation data using its native processing logic. Accordingly, the vehicle navigation system may process the navigation data to generate a proposed route to the desired destination (task 714). In addition, process 700 may provide navigation instructions corresponding to the proposed route (task 716), where such navigation instructions can be displayed, played, broadcast, or otherwise conveyed to the operator of the vehicle. The navigation instructions may be provided in real-time in response to the current vehicle location, and in accordance with known vehicle navigation system techniques.

If the operator of the vehicle remains on track toward the desired destination (query task 718), then navigation process 700 may simply continue to provide the corresponding navigation instructions (task 716). If, however, the vehicle goes off track, then it may be desirable to recalculate the proposed route based upon the current vehicle position. This may be performed automatically if the vehicle navigation system includes such functionality. Alternatively, process 700 may prompt the operator to re-connect the loaded storage device to the vehicle navigation system (task 720) to initiate another downloading of the mapping data (task 710). In this manner, process 700 can simply recalculate the proposed route based upon the current vehicle position and the desired destination, which is conveyed in the downloaded mapping data. Such functionality may be desirable in vehicle navigation systems that do not utilize DVD-ROM map databases. In other words, this feature enables a vehicle navigation system to leverage the map database utilized by the mapping application and, therefore, the vehicle navigation system need not include its own map database.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A navigation system for instructing an operator of a vehicle, the system comprising:
an interactive computer-based mapping application configured to generate mapping data corresponding to a user-entered destination, the mapping data being formatted for native compatibility with the mapping application;
an onboard data converter configured to convert the mapping data into navigation data corresponding to the destination; and
an onboard vehicle navigation system configured to process the navigation data using native navigation system processing logic, and configured to generate a proposed route in response to the navigation data; wherein the mapping data is not fully compatible with the onboard vehicle navigation system and wherein the navigation data is formatted for native compatibility with the onboard vehicle navigation system.

2. (canceled)

3. (canceled)

4. A navigation system according to claim 1, the onboard vehicle navigation system comprising the data converter.

5. A navigation system according to claim 4, further comprising a portable data storage device configured to store the mapping data, wherein the onboard vehicle navigation system is configured to receive the portable data storage device to facilitate transfer of the mapping data from the portable data storage device to the onboard vehicle navigation system.

6. A navigation system according to claim 1, the mapping data including location information for the destination.

7. A navigation system according to claim 1, the mapping data including route information for the destination.

8. A navigation system for instructing an operator of a vehicle, the system comprising:
a portable data storage device configured to store mapping data generated by an interactive computer-based mapping application, the mapping data corresponding to a destination for the operator, and the mapping data being formatted for native compatibility with the mapping application; and
an onboard vehicle navigation system configured to receive the portable data storage device to facilitate transfer of the mapping data from the portable data storage device to the onboard vehicle navigation system, the onboard vehicle navigation system being configured to reformat the mapping data into navigation data formatted for native compatibility with the onboard vehicle navigagtion system , and to generate a proposed route in response to the navigation data, wherein the mapping data is not fully compatible with the onboard vehicle navigation system.

9. A navigation system according to claim 8, the onboard vehicle navigation system being configured to provide navigation instructions corresponding to the proposed route.

10. A navigation system according to claim 8, the onboard vehicle navigation system comprising a data converter configured to convert the mapping data downloaded from the portable data storage device into the navigation data corresponding to the destination, wherein the onboard vehicle navigation system is configured to process the navigation data using native navigation system processing logic to generate the proposed route.

11. A navigation system according to claim 8, wherein the portable data storage device includes the interactive computer-based mapping application.

12. (canceled)

13. A navigation system according to claim 8, the portable data storage device comprising a flash memory device.

14. A navigation system according to claim 8, the portable data storage device comprising an optical memory disk.

15. A navigation system according to claim 8, the portable data storage device comprising a connector, wherein the onboard vehicle navigation system comprises a data port configured to receive the connector to facilitate downloading of data from the portable data storage device to the onboard vehicle navigation system.

16. A navigation method for instructing an operator of a vehicle, the method comprising:
generating mapping data with an interactive computer-based mapping application, the mapping data corresponding to a user-entered destination for the operator, and the mapping data being formatted for native compatibility with the mapping application;
storing the mapping data on a portable data storage device to obtain a loaded storage device;
establishing data connectivity between the loaded storage device and an onboard vehicle navigation system;
downloading the mapping data from the loaded storage device to the onboard vehicle navigation system; and
converting the mapping data into navigation data formatted for native compatibility with the onboard vehicle navigation system, wherein the mapping data is not fUlly compatible with the onboard vehicle navigation system.

17. (canceled)

18. (canceled)

19. A method according to claim 16, further comprising processing the navigation data to generate a proposed route to the destination.

20. A method according to claim 16, wherein establishing data connectivity between the loaded storage device and the onboard vehicle navigation system comprises coupling a connector of the loaded storage device to a data port of the onboard vehicle navigation system, the data port being configured to mate with the connector.
